(19) United States
(12) Patent Application Publication
(10) Pub. No.: US 2023/0359100 A1
(43) Pub. Date: Nov. 9, 2023

(54) LIGHT BEAM DIRECTION CONTROL ELEMENT, DISPLAY DEVICE, AND METHOD FOR DRIVING LIGHT BEAM DIRECTION CONTROL ELEMENT

(71) Applicant: TIANMA JAPAN, LTD., Kawasaki (JP)

(72) Inventor: Hiroshi UEYAMA, Kawasaki (JP)

(73) Assignee: TIANMA JAPAN, LTD., Kawasaki (JP)

(21) Appl. No.: 18/312,132

(22) Filed: May 4, 2023

(30) Foreign Application Priority Data
May 6, 2022 (JP) 2022-076417
Jan. 20, 2023 (JP) 2023-006928

(51) Int. Cl. G02F 1/29

(52) U.S. Cl. CPC G02F 1/291

(57) ABSTRACT

A light beam direction control element includes a light beam direction controller and a controller. The light beam direction controller includes light transmitting regions sandwiched between a first light transmissive substrate and a second light transmissive substrate, light absorbing regions located between light transmitting regions, a light transmissive dispersion medium sealingly contained in the light absorbing regions, and electrophoretic particles dispersed in the light transmissive dispersion medium. The controller, by controlling voltage applied to the electrophoretic particles from a first light transmissive electrode on the first light transmissive substrate and second light transmissive electrodes and third light transmissive electrodes on the second light transmissive substrate, causes the electrophoretic particles to localize to the second light transmissive substrate side and also causes the electrophoretic particles to flow between a space over each of the second light transmissive electrodes and a space over an adjacent one of the third light transmissive electrode.

### CROSS-REFERENCE TO RELATED APPLICATIONS

This application claims the benefit of Japanese Patent Application No. 2022-76417, filed on May 6, 2022, and Japanese Patent Application No. 2023-006928, filed on Jan. 20, 2023, of which the entity of the disclosures is incorporated by reference herein.

### FIELD OF THE INVENTION

This application relates generally to a light beam direction control element, a display device, and a method for driving the light beam direction control element.

### BACKGROUND OF THE INVENTION

Light beam direction control elements that control an emission range of transmitted light have been known. For example, Japanese Patent No. 6443691 discloses an optical element including first and second transparent substrates, a conductive light-blocking pattern arranged on the first transparent substrate, a transparent conductive film arranged on the second transparent substrate, a plurality of light transmitting regions arranged on the first transparent substrate, electrophoretic elements that are arranged between adjacent light transmitting regions and contain light-blocking electrophoretic particles and a light transmissive dispersing agent. The optical element of Japanese Patent No. 6443691 changes the dispersion state of the electrophoretic particles by adjusting a potential difference between the conductive light-blocking pattern and the transparent conductive film and thereby changes the emission range of light transmitted through the light transmitting regions and the dispersing agent.

The optical element of Japanese Patent No. 6443691 causes the electrophoretic particles to localize to a vicinity of the conductive light-blocking pattern by setting relative potential of the conductive light-blocking pattern with respect to the transparent conductive film to a polarity opposite to the surface charge of the electrophoretic particles and thereby achieves a wide viewing angle state (wide emission range). When the electrophoretic particles are caused to localize to a vicinity of one electrode for a long period of time, there is a possibility that, because of the electrophoretic particles polarizing, the electrophoretic particles adhere to one another and the electrophoretic particles change to large masses. In addition, there is also a possibility that the electrophoretic particles become less likely to be dispersed. Because of these phenomena, reliability of the optical element deteriorates.

### SUMMARY OF THE INVENTION

A light beam direction control element according to a first aspect includes:
a light beam direction controller; and
a controller to control an angular distribution of light emitted from the light beam direction controller,
in which the light beam direction controller includes:
a first light transmissive substrate having a first light transmissive electrode on a principal surface;
a second light transmissive substrate opposed to the first light transmissive substrate and having second light transmissive electrodes and third light transmissive electrodes on a principal surface opposed to the principal surface of the first light transmissive substrate;
a plurality of light transmitting regions arranged in line in a predetermined direction and sandwiched between the first light transmissive substrate and the second light transmissive substrate;
a plurality of light absorbing regions located between the light transmitting regions;
a light transmissive dispersion medium sealingly contained in the light absorbing regions; and
electrophoretic particles absorbing light, dispersed in the light transmissive dispersion medium, and having a dispersion state changing by applied voltage,
the second light transmissive electrodes and the third light transmissive electrodes are arranged at positions overlapping the light absorbing regions with a gap interposed between each of the second light transmissive electrodes and an adjacent one of the third light transmissive electrodes, and
the controller, by controlling voltage applied to the electrophoretic particles from the first light transmissive electrode, the second light transmissive electrodes, and the third light transmissive electrodes, causes the electrophoretic particles to localize to the second light transmissive substrate side and also causes the electrophoretic particles to flow between a space over each of the second light transmissive electrodes and a space over an adjacent one of the third light transmissive electrodes.

A display device according to a second aspect includes:
the light beam direction control element described above;
a display panel,
in which the light beam direction controller of the light beam direction control element is arranged on a display surface of the display panel.

A display device according to a third aspect includes:
the light beam direction control element described above;
a transmission-type liquid crystal display panel; and
a backlight arranged on an opposite side to a display surface of the transmission-type liquid crystal display panel and to supply the transmission-type liquid crystal display panel with light,
in which the light beam direction controller of the light beam direction control element is arranged between the transmission-type liquid crystal display panel and the backlight.

A method for driving a light beam direction control element according to a fourth aspect includes:
causing electrophoretic particles dispersed in a dispersion medium, the dispersion medium being sealingly contained in light absorbing regions located between a first light transmissive substrate and a second light transmissive substrate, to localize to the second light transmissive substrate side by controlling voltage applied between a first light transmissive electrode on the first light transmissive substrate and second light transmissive electrodes and third light transmissive electrodes on the second light transmissive substrate; and
causing the electrophoretic particles having been caused to localize to the second light transmissive substrate side to flow between a space over each of the second light transmissive electrodes and a space over an adjacent one of the third light transmissive electrodes by controlling voltage applied between the second light transmissive electrode and the third light transmissive electrode.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic diagram illustrating a light beam direction control element according to Embodiment 1;

FIG. 2 is a cross-sectional view illustrating a light beam direction controller according to Embodiment 1;

FIG. 3 is a schematic diagram illustrating a display device according to Embodiment 1;

FIG. 4 is a plan view illustrating light blocking layers, second light transmissive electrodes, and third light transmissive electrodes according to Embodiment 1;

FIG. 5 is a block diagram illustrating a configuration of a controller according to Embodiment 1;

FIG. 6 is a schematic diagram describing flow of electrophoretic particles according to Embodiment 1;

FIG. 7 is a diagram illustrating a hardware configuration of the controller according to Embodiment 1;

FIG. 8 is a schematic diagram indicating potentials at a first light transmissive electrode, the second light transmissive electrodes, and the third light transmissive electrodes in a narrow viewing angle mode and a wide viewing angle mode according to Embodiment 1;

FIG. 9 is a schematic diagram illustrating the narrow viewing angle mode according to Embodiment 1;

FIG. 10 is a diagram illustrating an angular distribution of emitted light of the light beam direction controller in a plane parallel with an XZ plane according to Embodiment 1;

FIG. 11 is a schematic diagram illustrating the wide viewing angle mode according to Embodiment 1;

FIG. 12 is a flowchart illustrating drive processing of the light beam direction control element according to Embodiment 1;

FIG. 13 is a perspective view illustrating light transmitting regions and a light absorbing region according to Embodiment 2;

FIG. 14 is a cross-sectional view illustrating a light beam direction controller according to Embodiment 2;

FIG. 15 is a plan view illustrating the light transmitting regions, second light transmissive electrodes, third light transmissive electrodes, a first wiring, and a second wiring according to Embodiment 2;

FIG. 16 is a schematic diagram illustrating a narrow viewing angle mode according to Embodiment 2;

FIG. 17 is a diagram illustrating an angular distribution of emitted light of the light beam direction controller in a plane parallel with a YZ plane according to Embodiment 2;

FIG. 18 is a schematic diagram describing flow of electrophoretic particles according to Embodiment 2;

FIG. 19 is a schematic diagram illustrating a light beam direction controller according to a variation;

FIG. 20 is a schematic diagram illustrating a display device according to another variation;

FIG. 21 is a schematic diagram illustrating a display device according to still another variation;

FIG. 22 is a diagram illustrating an evaluation result according to Example 1;

FIG. 23 is a diagram illustrating an evaluation result according to Example 2;

FIG. 24 is a perspective view illustrating light transmitting regions and a light absorbing region according to Example 3;

FIG. 25 is a plan view illustrating second light transmissive electrodes and third light transmissive electrodes according to Example 3; and

FIG. 26 is a diagram illustrating an evaluation result according to Example 3.

### DETAILED DESCRIPTION OF THE INVENTION

A light beam direction control element and a display device according to embodiments are described below with reference to the drawings.

### Embodiment 1

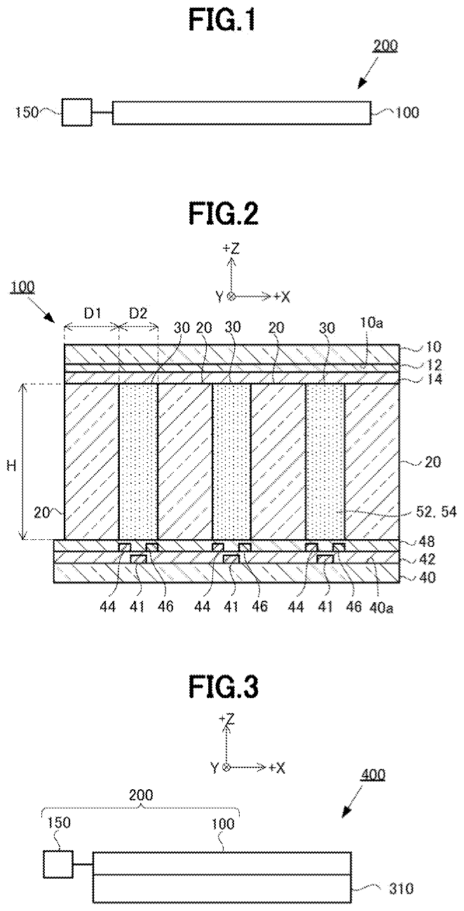

With reference to FIGS. 1 to 12, a light beam direction control element 200 and a display device 400 according to the present embodiment are described. The light beam direction control element 200 includes, as illustrated in FIG. 1, a light beam direction controller 100 and a controller 150.

The light beam direction controller 100 includes, as illustrated in FIG. 2, a first light transmissive substrate 10, light transmitting regions 20, light absorbing regions 30, and a second light transmissive substrate 40. The light transmitting regions 20 and the light absorbing regions 30 are sandwiched between the first light transmissive substrate 10 and the second light transmissive substrate 40. In each of the light absorbing regions 30, a light transmissive dispersion medium 52 and electrophoretic particles 54 are sealingly contained. In the light beam direction controller 100, a dispersion state of the electrophoretic particles 54 in the light transmissive dispersion medium 52 changes by voltage applied to the electrophoretic particles 54 and an angular distribution of emitted light emitted from the light beam direction controller 100 changes. Note that, to facilitate understanding, in the description of the present disclosure, description is made assuming that, in FIG. 2, the rightward direction of the light beam direction controller 100 (the rightward direction of the plane of paper) is the +X-direction, the upward direction of the light beam direction controller 100 (the upward direction of the plane of paper) is the +Z-direction, and a direction orthogonal to the +X-direction and the +Z-direction (the depth direction of the plane of paper) is the +Y-direction. In addition, the X-direction, the Y-direction, and the Z-direction are also referred to as the right and left direction, the depth direction or the up and down directions, and the height direction, respectively.

Returning to FIG. 1, the controller 150, by controlling voltage applied to the electrophoretic particles 54, controls the angular distribution of emitted light emitted from the light beam direction controller 100.

The light beam direction control element 200 constitutes the display device 400 in conjunction with a display panel 310, as illustrated in FIG. 3. The display device 400 is mounted on a smartphone, a laptop computer, a vehicle, an information display, or the like. The display panel 310 displays characters, an image, or the like. The display panel 310 is a liquid crystal display panel, an organic electro luminescence (EL) display panel, a micro light emitting diode (LED) display panel, or the like.

The light beam direction controller 100 controls an angular distribution of light that is emitted from the display panel 310 and transmitted through the light beam direction controller 100 (an angular distribution of emitted light). The light beam direction controller 100 is arranged on, for example, a display surface of the display panel 310.

Returning to FIG. 2, the first light transmissive substrate 10 of the light beam direction controller 100 transmits visible light. The first light transmissive substrate 10 is, for example, a flat plate-shaped glass substrate. A first principal surface 10a of the first light transmissive substrate 10 is opposed to a first principal surface 40a of the second light transmissive substrate 40, which is described later.

The first light transmissive substrate 10 has a first light transmissive electrode 12 and a first insulating layer 14 formed thereon. In the present embodiment, the first light transmissive electrode 12 is formed of indium tin oxide (ITO) on the entire first principal surface 10a. The first light transmissive electrode 12 is connected to the controller 150 via not-illustrated wiring. In addition, the first insulating layer 14 is formed on the first light transmissive electrode 12. The first insulating layer 14 is formed of, for example, silicon oxide (SiO₂).

The light transmitting regions 20 of the light beam direction controller 100 are regions that transmit visible light. The light transmitting regions 20 are sandwiched between the first principal surface 10a of the first light transmissive substrate 10 and the first principal surface 40a of the second light transmissive substrate 40. The light transmitting regions 20 are, for example, light transmitting layers that are formed of a resin having light transmissivity. Examples of the resin having light transmissivity include chemically amplified photoresist SU-8 (trade name, manufactured by Nippon Kayaku Co., Ltd.).

Each of the light transmitting regions 20 has a rectangular parallelepiped shape that extends in the Z-direction (height direction) and the Y-direction (depth direction). The light transmitting regions 20 are arranged in line in the X-direction. Height H of the light transmitting regions 20 (and the light absorbing regions 30) is, for example, 100 μm to 200 μm, and width D1 of each of the light transmitting regions 20 is, for example, 40 μm to 50 μm. In addition, gap D2 between adjacent light transmitting regions 20 (width of each of the light absorbing regions 30) is, for example, 10 μm to 60 μm.

Each of the light absorbing regions 30 of the light beam direction controller 100 is a region between adjacent light transmitting regions 20, as illustrated in FIG. 2. The light absorbing regions 30 are, as with light transmitting regions 20, sandwiched between the first principal surface 10a of the first light transmissive substrate 10 and the first principal surface 40a of the second light transmissive substrate 40. In addition, the light absorbing regions 30 are arranged in line in the X-direction, and each of the light absorbing regions 30 has a rectangular parallelepiped shape that extends in the Z-direction (height direction) and the Y-direction (depth direction). Width D2 of each of the light absorbing regions 30 is, for example, 10 μm to 60 μm. The light transmissive dispersion medium 52 and the electrophoretic particles 54 are sealingly contained in each of the light absorbing regions 30.

The second light transmissive substrate 40 of the light beam direction controller 100, as with the first light transmissive substrate 10, transmits visible light. The second light transmissive substrate 40 is, for example, a flat plate-shaped glass substrate. As illustrated in FIG. 2, the second light transmissive substrate 40 is opposed to the first light transmissive substrate 10. The first principal surface 40a of the second light transmissive substrate 40 is opposed to the first principal surface 10a of the first light transmissive substrate 10. The second light transmissive substrate 40 has light blocking layers 41, a second insulating layer 42, second light transmissive electrodes 44, third light transmissive electrodes 46, and a third insulating layer 48 formed thereon.

The light blocking layers 41 of the second light transmissive substrate 40 block light. The light blocking layers 41 are formed of, for example, chromium (Cr) on the first principal surface 40a of the second light transmissive substrate 40. When the light beam direction controller 100 is viewed in plan, each of the light blocking layers 41 is arranged between one of the second light transmissive electrodes 44 and an adjacent one of the third light transmissive electrodes 46 and extends in the Y-direction, as illustrated in FIG. 4. Note that, in FIG. 4, to facilitate understanding, the first light transmissive substrate 10, the second insulating layer 42, and the like are omitted.

The second insulating layer 42 of the second light transmissive substrate 40 covers the first principal surface 40a and the light blocking layers 41. The second insulating layer 42 is formed of, for example, silicon oxide (SiO₂).

The second light transmissive electrodes 44 of the second light transmissive substrate 40 are formed of ITO on the second insulating layer 42, as illustrated in FIG. 2. When the light beam direction controller 100 is viewed in plan, each of the second light transmissive electrodes 44 overlaps one of the light absorbing regions 30 and extends in the Y-direction along an edge on the −X side of the light absorbing region 30, as illustrated in FIG. 4. The second light transmissive electrodes 44 are connected to the controller 150 via a first wiring 61 formed on the second insulating layer 42. Width D3 of each of the second light transmissive electrodes 44 is, for example, 10 μm.

The third light transmissive electrodes 46 of the second light transmissive substrate 40 are formed of ITO on the second insulating layer 42, as illustrated in FIG. 2. When the light beam direction controller 100 is viewed in plan, each of the third light transmissive electrodes 46 overlaps one of the light absorbing regions 30 and extends in the Y-direction along an edge on the +X side of the light absorbing region 30, as illustrated in FIG. 4. Each of the third light transmissive electrodes 46 and an adjacent one of the second light transmissive electrodes 44 are formed with a predetermined gap D4 interposed therebetween. The third light transmissive electrodes 46 are connected to the controller 150 via a second wiring 62 formed on the second insulating layer 42. Width D5 of each of the third light transmissive electrodes 46 is, for example, 10 μm, as with the width D3 of each of the second light transmissive electrodes 44. Note that, in the present embodiment, the predetermined gap D4 is the same as the width of each of the light blocking layers 41.

The third insulating layer 48 of the second light transmissive substrate 40 covers the second insulating layer 42, the second light transmissive electrodes 44, and the third light transmissive electrodes 46, as illustrated in FIG. 2. The third insulating layer 48 is formed of, for example, polyimide.

The light transmissive dispersion medium 52 of the light beam direction controller 100 is sealingly contained in the light absorbing regions 30, as illustrated in FIG. 2. The light transmissive dispersion medium 52 transmits visible light. The light transmissive dispersion medium 52 disperses the electrophoretic particles 54.

The electrophoretic particles 54 of the light beam direction controller 100 are dispersed in the light transmissive dispersion medium 52. In addition, the electrophoretic particles 54 absorb visible light. The electrophoretic particles 54 are positively or negatively charged. The dispersion state of the electrophoretic particles 54 in the light transmissive dispersion medium 52 changes by voltage applied by the first light transmissive electrode 12, the second light transmissive electrodes 44, and the third light transmissive electrodes 46. The electrophoretic particles 54 are, for example, charged carbon black particles.

The light transmissive dispersion medium 52 and the electrophoretic particles 54 dispersed in the light transmissive dispersion medium 52 are sealingly contained in the light absorbing regions 30. Therefore, the light absorbing regions 30 function as an electrophoretic element in conjunction with the first light transmissive electrode 12, the second light transmissive electrodes 44, and the third light transmissive electrodes 46. The controller 150 controlling voltage applied to the electrophoretic particles 54 causes the dispersion state of the electrophoretic particles 54 to change and thereby enables the light absorbing regions 30 to function as light absorbing layers matching the dispersion state of the electrophoretic particles 54.

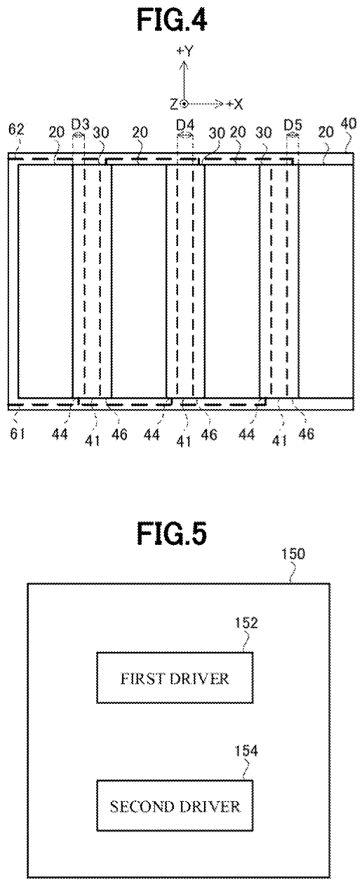

The controller 150, by controlling voltage applied to the electrophoretic particles 54 from the first light transmissive electrode 12, the second light transmissive electrodes 44, and the third light transmissive electrodes 46, controls the angular distribution of emitted light emitted from the light beam direction controller 100. The controller 150 does not apply voltage to the electrophoretic particles 54 in a narrow viewing angle mode (a state in which the angular distribution of emitted light is narrow), which is described later. In a wide viewing angle mode (a state in which the angular distribution of emitted light is wide), which is described later, the controller 150, by applying voltage to the electrophoretic particles 54, causes the electrophoretic particles 54 to localize to the side on which the second light transmissive substrate 40 is located and also causes the electrophoretic particles 54 to flow between each of the second light transmissive electrodes 44 and an adjacent one of the third light transmissive electrodes 46. The controller 150 includes, as illustrated in FIG. 5, a first driver 152 and a second driver 154.

The first driver 152 of the controller 150 applies DC voltage between the first light transmissive electrode 12 and the second light transmissive electrodes 44 and third light transmissive electrodes 46 in the wide viewing angle mode. Because of this configuration, DC voltage is applied to the electrophoretic particles 54 and the electrophoretic particles 54 localize to the second light transmissive substrate 40 side on which the second light transmissive electrodes 44 and the third light transmissive electrodes 46 are disposed.

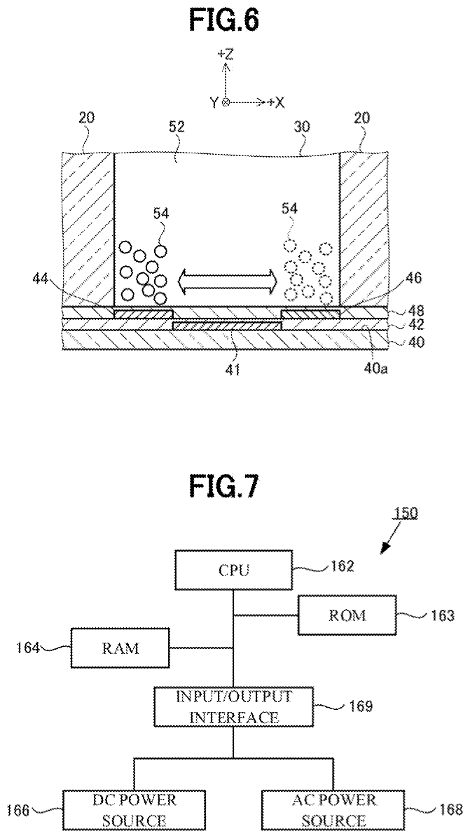

The second driver 154 of the controller 150 applies AC voltage between each of the second light transmissive electrodes 44 and an adjacent one of the third light transmissive electrodes 46 in the wide viewing angle mode. Because of this configuration, AC voltage is applied to the electrophoretic particles 54 having been caused to localize to the second light transmissive substrate 40 side and the electrophoretic particles 54 having been caused to localize flow between a space over each of the second light transmissive electrodes 44 and a space over an adjacent one of the third light transmissive electrodes 46, as illustrated in FIG. 6. Since the present embodiment causes the electrophoretic particles 54 having been caused to localize to flow between a space over each of the second light transmissive electrodes 44 and a space over an adjacent one of the third light transmissive electrodes 46, it is possible to prevent the electrophoretic particles 54 from polarizing and adhering to one another.

Operation of the light beam direction controller 100 and a specific example of voltage applied to the electrophoretic particles 54 are described later.

FIG. 7 illustrates a hardware configuration of the controller 150. The controller 150 includes, for example, a central processing unit (CPU) 162, a read only memory (ROM) 163, a random access memory (RAM) 164, a DC power source 166, an AC power source 168, and an input/output interface 169. The CPU 162 executes programs stored in the ROM 163. The ROM 163 stores programs, data, signals, and the like. The RAM 164 stores data. The DC power source 166 applies DC voltage between the first light transmissive electrode 12 and the second light transmissive electrodes 44 and third light transmissive electrodes 46. The AC power source 168 applies AC voltage between each of the second light transmissive electrodes 44 and an adjacent one of the third light transmissive electrodes 46. The input/output interface 169 inputs and outputs signals sent and received between the respective units, signals sent and received to and from an external device, and the like. Functions of the controller 150 are achieved by the CPU 162 executing programs stored in the ROM 163.

The operation of the light beam direction control element 200 is described below. In the following description, the operation of the light beam direction control element 200 is described, assuming that a surface light source (uniformly diffusing surface light source) 700 that provides uniform luminance when viewed from any direction is arranged on the second light transmissive substrate 40 side of the light beam direction controller 100. The light beam direction control element 200 controls an angular distribution of light 710 that is incident on the light beam direction controller 100 from the −Z-direction and emits the light 710 in the +Z-direction.

(Narrow Viewing Angle Mode)

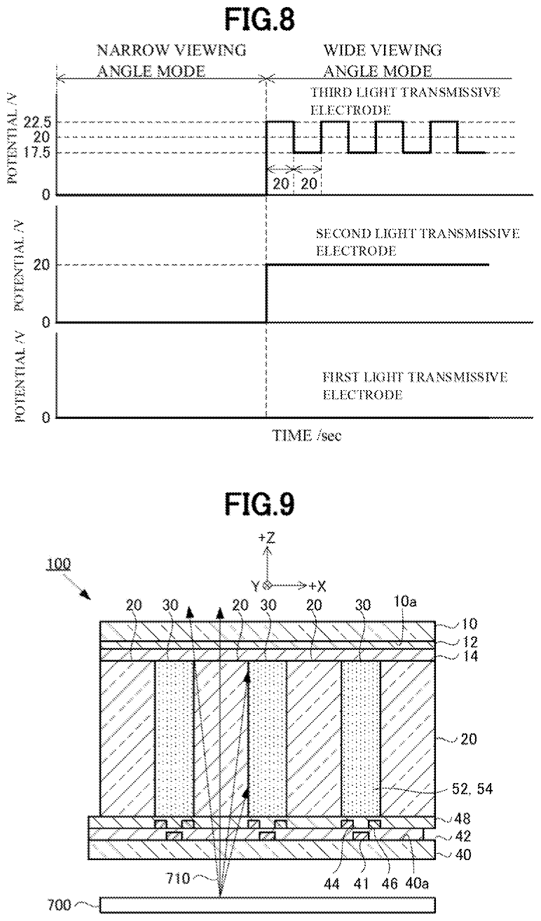

When the controller 150 sets potentials at the first light transmissive electrode 12, the second light transmissive electrodes 44, and the third light transmissive electrodes 46 to the same potential (for example, a ground potential), as illustrated in FIG. 8 and no voltage is applied to the electrophoretic particles 54, the electrophoretic particles 54 are dispersed uniformly over the whole of each of the light absorbing regions 30 and each of the light absorbing regions 30 functions as a light absorbing layer over the whole thereof. This state in which each of the light absorbing regions 30 functions as a light absorbing layer over the whole thereof is defined as the narrow viewing angle mode.

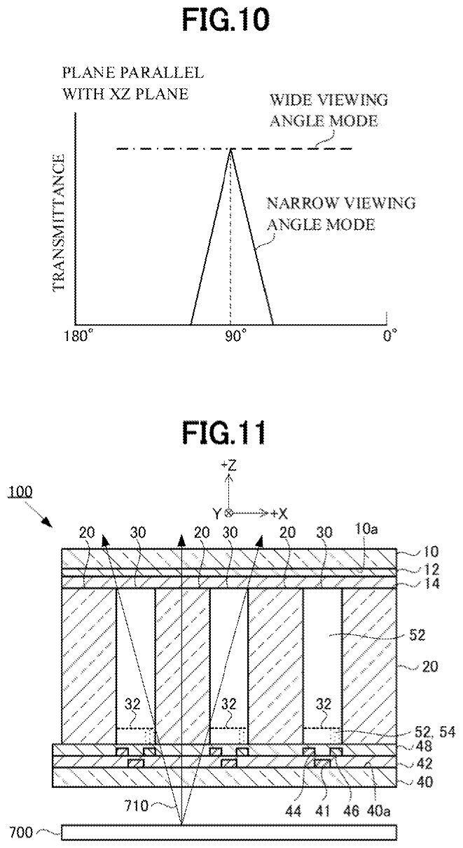

Since, when the light beam direction controller 100 in the narrow viewing angle mode is viewed in a cross section taken along a plane parallel with the XZ plane, the light transmitting regions 20, which have rectangular parallelepiped shapes, are arranged in the X-direction and each of the light absorbing regions 30 is located between adjacent light transmitting regions 20, light 710 other than light 710 pointing in directions within a vicinity of the +Z-direction among the light 710 that is incident from the surface light source 700 is absorbed by the light absorbing regions 30, as illustrated in FIG. 9. In addition, in the plane parallel with the XZ plane, light 710 pointing in directions within the vicinity of the +Z-direction among the light 710 that is incident from the surface light source 700 is emitted from the light beam direction controller 100. Therefore, when the +X-direction, the +Z-direction, and the −X-direction are defined as 0°, 90°, and 180°, respectively, emitted light from the light beam direction controller 100 in the narrow viewing angle mode has a narrow angular distribution within the vicinity of 90° (+Z-direction) in the plane parallel with the XZ plane, as illustrated in FIG. 10.

In a plane parallel with the YZ plane that includes one of the light transmitting regions 20, emitted light from the light beam direction controller 100 in the narrow viewing angle mode has a uniform angular distribution because the light transmitting region 20 extends in the Y-direction. In the other planes parallel with the YZ plane, light 710 that is incident from the surface light source 700 is absorbed by the light absorbing regions 30 because the light absorbing regions 30 extend in the Y-direction.

As described above, emitted light from the light beam direction controller 100 in the narrow viewing angle mode has a narrow angular distribution within the vicinity of 90° (+Z-direction) in a plane parallel with the XZ plane and has a uniform angular distribution in a plane parallel with the YZ plane that includes one of the light transmitting regions 20. Therefore, in the narrow viewing angle mode, the light beam direction control element 200 is capable of limiting a viewing angle in the right and left direction (X-direction) of the display device 400 to the vicinity of the front (+Z-direction).

(Wide Viewing Angle Mode)

When the controller 150 applies a DC voltage of 20 V between the first light transmissive electrode 12 and the second light transmissive electrodes 44 and third light transmissive electrodes 46 and applies a pulse-shaped AC voltage of ±2.5 V and 0.05 Hz between each of the second light transmissive electrodes 44 and an adjacent one of the third light transmissive electrodes 46, as illustrated in FIG. 8, the electrophoretic particles 54 localize to the second light transmissive substrate 40 side and also flow between a space over each of the second light transmissive electrodes 44 and a space over an adjacent one of the third light transmissive electrodes 46, as illustrated in FIG. 6. Therefore, as illustrated in FIG. 11, only regions 32 each of which is located on the second light transmissive substrate 40 side of one of the light absorbing regions 30 function as light absorbing layers. This state in which only the regions 32 each of which is located on the second light transmissive substrate 40 side of one of the light absorbing regions 30 function as light absorbing layers is defined as the wide viewing angle mode.

In the wide viewing angle mode, only the regions 32 each of which is located on the second light transmissive substrate 40 side of one of the light absorbing regions 30 function as light absorbing layers. Therefore, when the light beam direction controller 100 in the wide viewing angle mode is viewed in a cross section taken along a plane parallel with the XZ plane, emitted light from the light beam direction controller 100 has a uniform angular distribution, as illustrated in FIG. 10. In addition, in a plane parallel with the YZ plane, emitted light from the light beam direction controller 100 in the wide viewing angle mode also has a uniform angular distribution. In the wide viewing angle mode, the light beam direction control element 200 does not limit the viewing angle of the display device 400. Since the present embodiment causes the electrophoretic particles 54 to localize to the second light transmissive substrate 40 side of each of the light absorbing regions 30 and to also flow between a space over each of the second light transmissive electrodes 44 and a space over an adjacent one of the third light transmissive electrodes 46, it is possible to prevent the electrophoretic particles 54 from polarizing and adhering to one another.

Frequency of the AC voltage applied between each of the second light transmissive electrodes 44 and an adjacent one of the third light transmissive electrodes 46 in the wide viewing angle mode is preferably 0.02 Hz or more and 0.05 Hz or less. When the frequency of the AC voltage is lower than 0.02 Hz, the electrophoretic particles 54 stay in a space over one of a second light transmissive electrode 44 and a third light transmissive electrode 46 for a long period of time and the electrophoretic particles 54 become likely to polarize and adhere to one another. On the other hand, when the frequency of the AC voltage is higher than 0.05 Hz, the electrophoretic particles 54 remain between each of the second light transmissive electrodes 44 and an adjacent one of the third light transmissive electrodes 46 and there is a possibility that a short circuit occurs between the second light transmissive electrode 44 and the third light transmissive electrode 46.

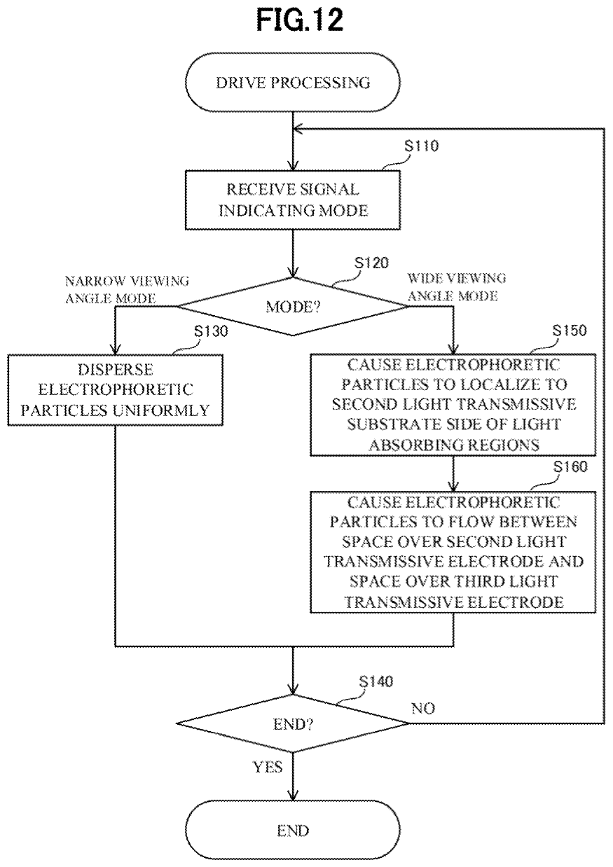

Next, with reference to FIG. 12, drive processing of the light beam direction control element 200 is described. When the light beam direction control element 200 is supplied with power, the controller 150 receives a signal indicating a mode from an external device (for example, a smartphone having the display device 400 mounted thereon) (step S110).

The controller 150 determines which mode the received signal indicates (step S120) and, when the received signal indicates the narrow viewing angle mode (step S120; the narrow viewing angle mode), controls the potentials of the first light transmissive electrode 12, the second light transmissive electrodes 44, and the third light transmissive electrodes 46 to be the same and thereby does not apply voltage to the electrophoretic particles 54 and disperses the electrophoretic particles 54 uniformly over the whole of each of the light absorbing regions 30 (step S130). When the controller 150 receives a signal indicating the end of the drive processing from the external device (step S140; YES), the drive processing of the light beam direction control element 200 is terminated. When the controller 150 has not received the signal indicating the end of the drive processing from the external device (step S140; NO), the drive processing of the light beam direction control element 200 returns to the reception of a signal indicating a mode (step S110) and the controller 150 maintains the narrow viewing angle mode until receiving a signal indicating the next mode.

When the received signal indicates the wide viewing angle mode (step S120; the wide viewing angle mode), the controller 150 controls voltage applied between the first light transmissive electrode 12 of the first light transmissive substrate 10 and the second light transmissive electrodes 44 and the third light transmissive electrodes 46 of the second light transmissive substrate 40 and causes the electrophoretic particles 54 to localize to the second light transmissive substrate 40 side of each of the light absorbing regions 30 (step S150). Specifically, the controller 150 applies DC voltage (for example, 20 V) between the first light transmissive electrode 12 and the second light transmissive electrodes 44 and third light transmissive electrodes 46.

Further, the controller 150, by controlling voltage applied between each of the second light transmissive electrodes 44 and an adjacent one of the third light transmissive electrodes 46, causes the electrophoretic particles 54 having been caused to localize to the second light transmissive substrate 40 side of a corresponding one of the light absorbing regions 30 to flow between a space over the second light transmissive electrode 44 and a space over the third light transmissive electrode 46 (step S160). Specifically, the controller 150, while applying DC voltage between the first light transmissive electrode 12 and the second light transmissive electrodes 44 and third light transmissive electrodes 46, applies AC voltage (for example, ±2.5 V and 0.05 Hz) between each of the second light transmissive electrodes 44 and an adjacent one of the third light transmissive electrodes 46.

When the controller 150 receives a signal indicating the end of the drive processing from the external device (step S140; YES), the drive processing of the light beam direction control element 200 is terminated. When the controller 150 has not received the signal indicating the end of the drive processing from the external device (step S140; NO), the drive processing of the light beam direction control element 200 returns to the reception of a signal indicating a mode (step S110) and the controller 150 maintains the wide viewing angle mode until receiving a signal indicating the next mode.

Since the present embodiment causes the electrophoretic particles 54 having been caused to localize to the second light transmissive substrate 40 side of each of the light absorbing regions 30 to flow between a space over a corresponding one of the second light transmissive electrodes 44 and a space over a corresponding one of the third light transmissive electrodes 46, it is possible to prevent the electrophoretic particles 54 from polarizing and adhering to one another.

As described above, in the narrow viewing angle mode in which no voltage is applied to the electrophoretic particles 54, the light beam direction control element 200 is capable of limiting the angular distribution of emitted light in the X-direction to a vicinity of the front. In addition, in the wide viewing angle mode in which voltage is applied to the electrophoretic particles 54, the light beam direction control element 200 is capable of broadening the angular distribution of emitted light. Since, in the wide viewing angle mode, the light beam direction control element 200 causes the electrophoretic particles 54 having been caused to localize to the second light transmissive substrate 40 side of each of the light absorbing regions 30 to flow between a space over a corresponding one of the second light transmissive electrodes 44 and a space over a corresponding one of the third light transmissive electrodes 46, it is possible to prevent the electrophoretic particles 54 from adhering to one another. Since the light beam direction control element 200 is capable of preventing the electrophoretic particles 54 from adhering to one another, reliability of the light beam direction control element 200 is improved.

### Embodiment 2

In Embodiment 1, each of the light transmitting regions 20 in the light beam direction controller 100 has a rectangular parallelepiped shape, and each of the light absorbing regions 30 in the light beam direction controller 100 also has a rectangular parallelepiped shape. The light transmitting regions 20 and the light absorbing regions 30 in the light beam direction controller 100 may be formed in other shapes.

In a light beam direction control element 200 of the present embodiment, the configuration of a light beam direction controller 100 is different from that in Embodiment 1. The configuration of a controller 150 of the present embodiment is the same as that in Embodiment 1.

The light beam direction controller 100 of the present embodiment, as with the light beam direction controller 100 in Embodiment 1, includes a first light transmissive substrate 10, light transmitting regions 20, a light absorbing region 30, and a second light transmissive substrate 40. The configuration of the first light transmissive substrate 10 of the present embodiment is the same as that in Embodiment 1.

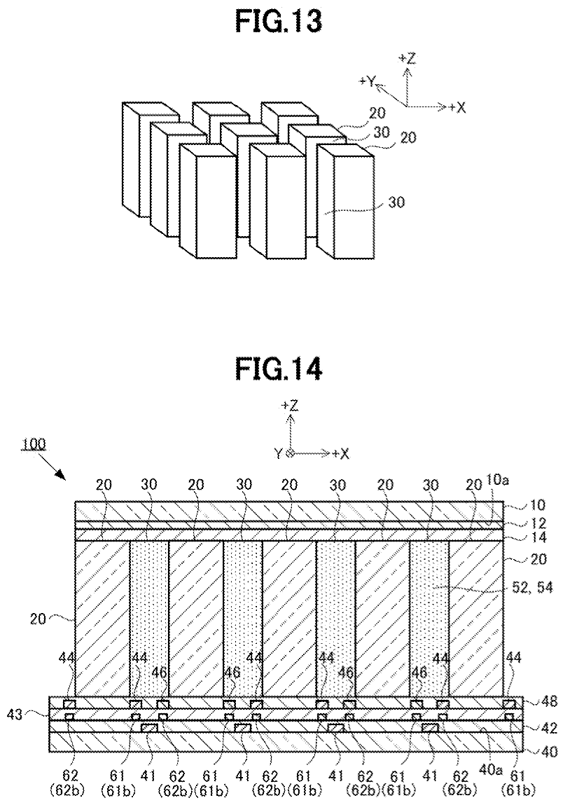

The light transmitting regions 20 of the present embodiment have quadrangular prism shapes and are arranged in a matrix in the X-direction and the Y-direction, as illustrated in FIG. 13. The other configuration of the light transmitting regions 20 of the present embodiment is the same as the configuration of the light transmitting regions 20 in Embodiment 1.

The light absorbing region 30 of the present embodiment is, as with the light absorbing regions 30 in Embodiment 1, a region between adjacent light transmitting regions 20. Since, in the present embodiment, the quadrangular prism-shaped light transmitting regions 20 are arranged in a matrix, the light absorbing region 30 forms a lattice-shaped region, as illustrated in FIG. 13. The other configuration of the light absorbing region 30 of the present embodiment is the same as the configuration of the light absorbing regions 30 in Embodiment 1.

The second light transmissive substrate 40 of the present embodiment, as with the second light transmissive substrate 40 in Embodiment 1, transmits visible light. As illustrated in FIG. 14, the second light transmissive substrate 40 is opposed to the first light transmissive substrate 10. A first principal surface 40a of the second light transmissive substrate 40 is opposed to a first principal surface 10a of the first light transmissive substrate 10. The second light transmissive substrate 40 has a light blocking layer 41, a second insulating layer 42, a wiring insulating layer 43, second light transmissive electrodes 44, third light transmissive electrodes 46, a third insulating layer 48, a first wiring 61, and a second wiring 62 formed thereon.

The light blocking layer 41 of the present embodiment, as with the light blocking layers 41 in Embodiment 1, blocks light. The light blocking layer 41 of the present embodiment is also formed of, for example, chromium (Cr) on the first principal surface 40a of the second light transmissive substrate 40. When the light beam direction controller 100 is viewed in plan, the light blocking layer 41 is formed in a lattice shape and is located between the second light transmissive electrodes 44 and the third light transmissive electrodes 46.

The second insulating layer 42 of the present embodiment covers the first principal surface 40a and the light blocking layer 41, as illustrated in FIG. 14. The second insulating layer 42 of the present embodiment is formed of, for example, silicon oxide (SiO₂). On the second insulating layer 42 of the present embodiment, the first wiring 61 and the second wiring 62 of the present embodiment are formed of, for example, ITO. The first wiring 61 and the second wiring 62 of the present embodiment are described later.

The wiring insulating layer 43 covers the second insulating layer 42, the first wiring 61, and the second wiring 62. The wiring insulating layer 43 is formed of, for example, silicon oxide (SiO₂). On the wiring insulating layer 43, the second light transmissive electrodes 44 and the third light transmissive electrodes 46 of the present embodiment are formed. The second light transmissive electrodes 44 and the third light transmissive electrodes 46 of the present embodiment are described later.

The third insulating layer 48 of the present embodiment covers the wiring insulating layer 43, the second light transmissive electrodes 44, and the third light transmissive electrodes 46. The third insulating layer 48 of the present embodiment is formed of, for example, polyimide.

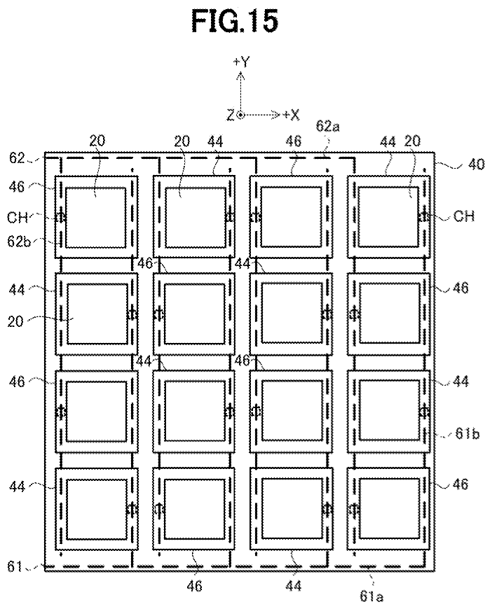

When the light beam direction controller 100 is viewed in plan, as illustrated in FIG. 15, each of the second light transmissive electrodes 44 and the third light transmissive electrodes 46 of the present embodiment is formed in a hollow square and surrounds one light transmitting region 20. In addition, the second light transmissive electrodes 44 and the third light transmissive electrodes 46 each of which surrounds a light transmitting region 20 are alternately arranged in the X-direction and the Y-direction. This arrangement causes the second light transmissive electrodes 44 and the third light transmissive electrodes 46 of the present embodiment to be arranged at positions overlapping the light absorbing region 30 with gaps interposed between each of the second light transmissive electrodes 44 and adjacent ones of the third light transmissive electrodes 46, as illustrated in FIG. 14.

The second light transmissive electrodes 44 of the present embodiment are connected to the controller 150 via the first wiring 61. The first wiring 61 of the present embodiment is formed in a comb-teeth shape, as illustrated in FIG. 15. The first wiring 61 includes a base portion 61a and a plurality of tooth portions 61b. When viewed in plan, the base portion 61a of the first wiring 61 is located at an edge on the −Y side of the second light transmissive substrate 40 and extends in the X-direction. Each of the tooth portions 61b of the first wiring 61 is branched from the base portion 61a and extends in the +Y-direction, and overlaps sides on the +X side of second light transmissive electrodes 44 and third light transmissive electrodes 46 that are arranged in line in the Y-direction. The second light transmissive electrodes 44 and the tooth portions 61b of the first wiring 61 are connected via contact holes CH in the wiring insulating layer 43.

The third light transmissive electrodes 46 of the present embodiment are connected to the controller 150 via the second wiring 62. The second wiring 62 of the present embodiment is, as with the first wiring 61, formed in a comb-teeth shape. The second wiring 62 includes a base portion 62a and a plurality of tooth portions 62b. When viewed in plan, the base portion 62a of the second wiring 62 is located at an edge on the +Y side of the second light transmissive substrate 40 and extends in the X-direction. Each of the tooth portions 62b of the second wiring 62 is branched from the base portion 62a and extends in the −Y-direction, and overlaps sides on the −X side of second light transmissive electrodes 44 and third light transmissive electrodes 46 that are arranged in line in the Y-direction. The third light transmissive electrodes 46 and the tooth portions 62b of the second wiring 62 are connected via contact holes CH in the wiring insulating layer 43. Note that, in FIG. 15, the second insulating layer 42, the wiring insulating layer 43, and the like are omitted to facilitate understanding.

A light transmissive dispersion medium 52 and a configuration of the light transmissive dispersion medium 52 of the present embodiment are the same as those in Embodiment 1. The light transmissive dispersion medium 52 and electrophoretic particles 54 dispersed in the light transmissive dispersion medium 52 are sealingly contained in the light absorbing region 30.

Next, operation of the light beam direction control element 200 of the present embodiment is described below. As with Embodiment 1, the operation of the light beam direction control element 200 of the present embodiment is described, assuming that a surface light source 700 is arranged on the second light transmissive substrate 40 side of the light beam direction controller 100 of the present embodiment.

(Narrow Viewing Angle Mode)

In a narrow viewing angle mode of the present embodiment, as with Embodiment 1, no voltage is applied to the electrophoretic particles 54 and the light absorbing region 30 functions as a light absorbing layer over the whole thereof.

Since, when the light beam direction controller 100 in the narrow viewing angle mode is viewed in a cross section taken along a plane parallel with the XZ plane including the light transmitting regions 20, the light transmitting regions 20, which have quadrangular prism shapes, are arranged in the X-direction and the light absorbing region 30 is located between adjacent light transmitting regions 20, light 710 other than light 710 pointing in directions within a vicinity of the +Z-direction among the light 710 that is incident from the surface light source 700 is, as with the narrow viewing angle mode in Embodiment 1, absorbed by the light absorbing region 30. In addition, in the plane parallel with the XZ plane including the light transmitting regions 20, light 710 pointing in directions within the vicinity of the +Z-direction among the light 710 that is incident from the surface light source 700 is emitted from the light beam direction controller 100. On the other hand, in a plane parallel with the XZ plane including the lattice-shaped light absorbing region 30, the light 710 that is incident from the surface light source 700 is absorbed by the light absorbing region 30.

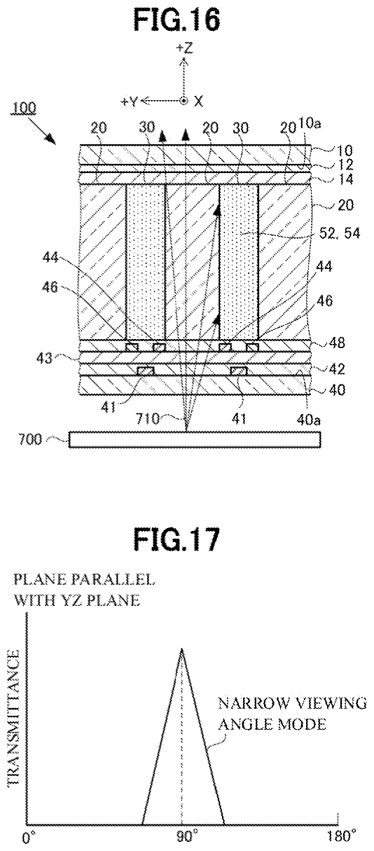

Since, when the light beam direction controller 100 in the narrow viewing angle mode is viewed in a cross section taken along a plane parallel with the YZ plane including the light transmitting regions 20, the light transmitting regions 20, which have quadrangular prism shapes, are arranged in the Y-direction and the light absorbing region 30 is located between adjacent light transmitting regions 20, light 710 other than light 710 pointing in directions within a vicinity of the +Z-direction among the light 710 that is incident from the surface light source 700 is absorbed by the light absorbing region 30, as illustrated in FIG. 16. In addition, in the plane parallel with the YZ plane including the light transmitting regions 20, light 710 pointing in directions within the vicinity of the +Z-direction among the light 710 that is incident from the surface light source 700 is emitted from the light beam direction controller 100. On the other hand, in a plane parallel with the YZ plane including the lattice-shaped light absorbing region 30, the light 710 that is incident from the surface light source 700 is absorbed by the light absorbing region 30. Therefore, when the +Y-direction, the +Z-direction, and the −Y-direction are defined as 0°, 90°, and 180°, respectively, in a plane parallel with the YZ plane, emitted light from the light beam direction controller 100 in the narrow viewing angle mode has a narrow angular distribution within the vicinity of 90° (+Z-direction), as illustrated in FIG. 17.

As described above, emitted light from the light beam direction control element 200 in the narrow viewing angle mode of the present embodiment has narrow angular distributions within the vicinity of 90° (+Z-direction) in a plane parallel with the XZ plane and in a plane parallel with the YZ plane. Therefore, in the narrow viewing angle mode of the present embodiment, the light beam direction control element 200 is capable of limiting viewing angles in the up and down direction (Y-direction) and the right and left direction (X-direction) of the display device 400 to the vicinity of the front (+Z-direction).

(Wide Viewing Angle Mode)

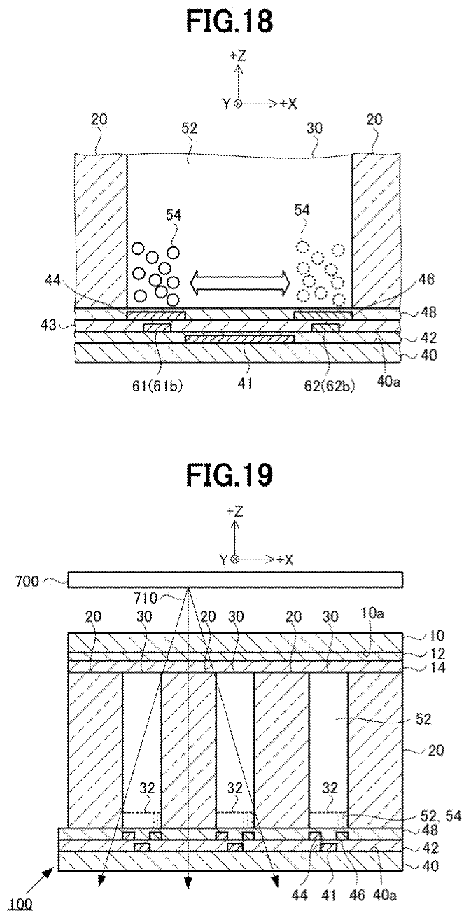

In a wide viewing angle mode of the present embodiment, as with Embodiment 1, for example, DC voltage of 20 V is applied between the first light transmissive electrode 12 and the second light transmissive electrodes 44 and third light transmissive electrodes 46 and a pulse-shaped AC voltage of ±2.5 V and 0.05 Hz is applied between each of the second light transmissive electrodes 44 and an adjacent one of the third light transmissive electrodes 46. Because of this configuration, in the present embodiment, the electrophoretic particles 54 also localize to the second light transmissive substrate 40 side and also flow between a space over each of the second light transmissive electrodes 44 and a space over an adjacent one of the third light transmissive electrodes 46, as illustrated in FIG. 18. In addition, in the present embodiment, only a region 32 located on the second light transmissive substrate 40 side of the light absorbing region 30 also functions as a light absorbing layer. Therefore, emitted light from the light beam direction controller 100 in the wide viewing angle mode in the present embodiment, as with Embodiment 1, has a uniform angular distribution. In the wide viewing angle mode, the light beam direction control element 200 of the present embodiment does not limit a viewing angle of the display device 400.

As described above, in the narrow viewing angle mode in which no voltage is applied to the electrophoretic particles 54, the light beam direction control element 200 of the present embodiment is capable of limiting the angular distributions of emitted light in the X-direction and the Y-direction to a vicinity of the front. In addition, in the wide viewing angle mode in which voltage is applied to the electrophoretic particles 54, the light beam direction control element 200 of the present embodiment is capable of broadening the angular distribution of emitted light. Since, in the present embodiment, the light beam direction control element 200 also causes the electrophoretic particles 54 having been caused to localize to the second light transmissive substrate 40 side of the light absorbing region 30 to flow between a space over each of the second light transmissive electrodes 44 and a space over an adjacent one of the third light transmissive electrodes 46, it is possible to prevent the electrophoretic particles 54 from adhering to one another. Since the light beam direction control element 200 is capable of preventing the electrophoretic particles 54 from adhering to one another, reliability of the light beam direction control element 200 of the present embodiment is improved.

Variations

Although the embodiments were specifically described above, the present disclosure can be embodied with various modifications without departing from the scope of the present disclosure.

For example, the first light transmissive substrate 10 and the second light transmissive substrate 40 may be formed of a resin having light transmissivity.

Although, in the embodiments, the second light transmissive substrate 40 has the light blocking layers 41 formed thereon, the second light transmissive substrate 40 does not have to have the light blocking layers 41 formed thereon. In addition, when the light beam direction controller 100 is viewed in plan, gaps may be interposed between each of the light blocking layers 41 and an adjacent one of the second light transmissive electrodes 44 and an adjacent one of the third light transmissive electrodes 46.

In the embodiments, the light 710 incident on the light beam direction controller 100 is incident on the light beam direction controller 100 from the second light transmissive substrate 40 side (−Z side). As illustrated in FIG. 19, the light 710 may be incident on the light beam direction controller 100 from the first light transmissive substrate 10 side (+Z side). In this case, the light beam direction control element 200 controls the angular distribution of the light 710 that is incident from the +Z-direction and emits the light 710 in the −Z-direction.

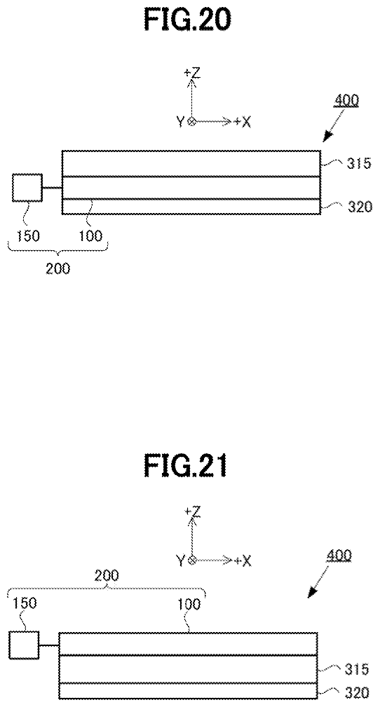

The display device 400 may include, as illustrated in FIG. 20, the light beam direction control element 200, a transmission-type liquid crystal display panel 315, and a backlight 320. The backlight 320 is arranged on the opposite side to a display surface of the transmission-type liquid crystal display panel 315 and supplies the transmission-type liquid crystal display panel 315 with light. The light beam direction controller 100 of the light beam direction control element 200 is arranged between the transmission-type liquid crystal display panel 315 and the backlight 320 and controls an angular distribution of light that is supplied from the backlight 320 to the transmission-type liquid crystal display panel 315. In addition, as illustrated in FIG. 21, the light beam direction controller 100 of the light beam direction control element 200 may be arranged on the display surface of the transmission-type liquid crystal display panel 315.

Preferred embodiments of the present disclosure were described above, but the present disclosure is not limited to a specific embodiment, and, in the present disclosure, the invention described in the appended claims and equivalents thereof are included.

### EXAMPLES

Although the present disclosure is more specifically described using the following examples, the present disclosure is not limited by the examples.

### Example 1

In the present example, light beam direction control elements 200 in Embodiment 1 each of which includes a different light transmissive dispersion medium 52 and different electrophoretic particles 54 from the others were produced. The states of the electrophoretic particles 54 of the produced light beam direction control elements 200 were visually observed while changing the voltage value and frequency of AC voltage (pulse-shaped) applied between each of the second light transmissive electrodes 44 and an adjacent one of the third light transmissive electrodes 46. The height H of the light transmitting regions 20 (and the light absorbing regions 30) is 120 μm, and the width D1 of each of the light transmitting regions 20 is 40 μm. The width D2 of each of the light absorbing regions 30 is 35 μm. The width D3 of each of the second light transmissive electrodes 44 and the width D5 of each of the third light transmissive electrodes 46 are 10 μm, and the gap D4 between each of the second light transmissive electrodes 44 and an adjacent one of the third light transmissive electrodes 46 is 15 μm. In addition, as the light transmissive dispersion medium 52 and the electrophoretic particles 54, the following three types of solvents were used:
Solvent 1 light transmissive dispersion medium: paraffin-based solvent, electrophoretic particles: positively charged (5 wt %);
Solvent 2 light transmissive dispersion medium: 1,1-diphenylethane, electrophoretic particles: positively charged (5 wt %); and
Solvent 3 light transmissive dispersion medium: 1-methylnaphthalene, electrophoretic particles: negatively charged (5 wt %).

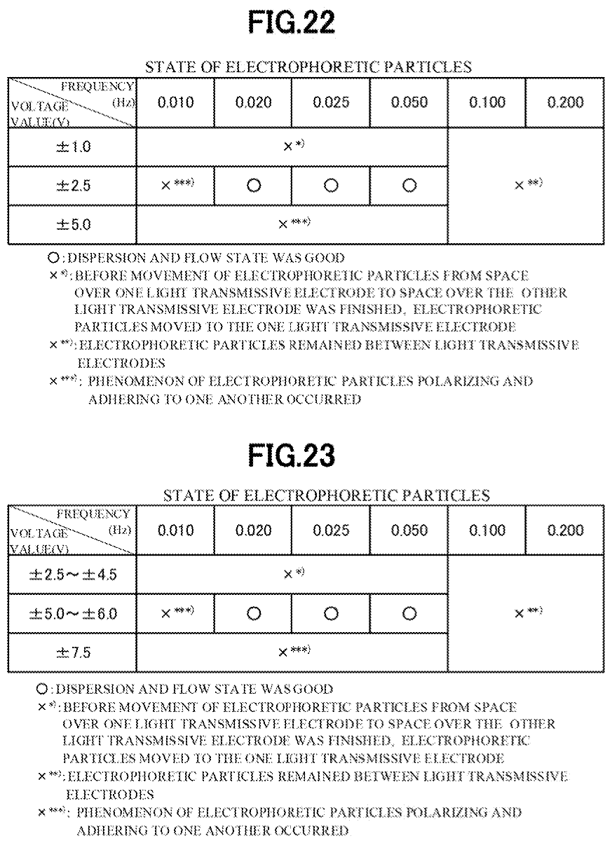

FIG. 22 illustrates an evaluation result of the light beam direction control element 200 using Solvent 1. Note that evaluation results of the light beam direction control elements 200 using Solvents 2 and 3 were similar to the evaluation result of the light beam direction control element 200 using Solvent 1.

As illustrated in FIG. 22, when the voltage value was ±1.0 V and the frequency was 0.01 Hz to 0.05 Hz, since, while the electrophoretic particles 54 were moving from a space over one light transmissive electrode (for example, a second light transmissive electrode 44) to a space over the other light transmissive electrode (for example, a third light transmissive electrode 46), the electrophoretic particles 54 moved to the one light transmissive electrode, the electrophoretic particles 54 having been caused to localize to the second light transmissive substrate 40 side were not able to be caused to flow between a space over each of the second light transmissive electrodes 44 and a space over an adjacent one of the third light transmissive electrodes 46. In addition, when the frequency was higher than or equal to 0.1 Hz, the electrophoretic particles 54 remained between each of the second light transmissive electrodes 44 and an adjacent one of the third light transmissive electrodes 46. When the voltage value was ±2.5 V and the frequency was 0.01 Hz and when the voltage value was ±5.0 V and the frequency was 0.01 Hz to 0.05 Hz, a phenomenon in which the electrophoretic particles 54 polarized and adhered to one another was observed.

When the voltage value was ±2.5 V and the frequency was 0.02 Hz to 0.05 Hz, it was confirmed that a good flow of the electrophoretic particles 54 was achieved. Therefore, the frequency of the AC voltage applied between each of the second light transmissive electrodes 44 and an adjacent one of the third light transmissive electrodes 46 is preferably 0.02 Hz or more and 0.05 Hz or less.

### Example 2

In the present example, a light beam direction control element 200 in which the gap D4 between each of the second light transmissive electrodes 44 and an adjacent one of the third light transmissive electrodes 46 of Example 1 and the width D2 of each light absorbing region were changed and that used Solvent 1 was produced. The produced light beam direction control element 200 was evaluated in a similar manner to Example 1. The gap D4 between each of the second light transmissive electrodes 44 and an adjacent one of the third light transmissive electrodes 46 is 40 μm, and the width D2 of each light absorbing region is 60 μm.

FIG. 23 illustrates an evaluation result of the light beam direction control element 200 of the present example. As illustrated in FIG. 23, when the voltage value was ±2.5 V to ±4.5 V and the frequency was 0.01 Hz to 0.05 Hz, since, while the electrophoretic particles 54 were moving from a space over one light transmissive electrode to a space over the other light transmissive electrode, the electrophoretic particles 54 moved to the one light transmissive electrode, the electrophoretic particles 54 having been caused to localize to the second light transmissive substrate 40 side were not able to be caused to flow between a space over each of the second light transmissive electrodes 44 and a space over an adjacent one of the third light transmissive electrodes 46. In addition, when the frequency was higher than or equal to 0.1 Hz, the electrophoretic particles 54 remained between each of the second light transmissive electrodes 44 and an adjacent one of the third light transmissive electrodes 46. When the voltage value was ±2.5 V and the frequency was 0.01 Hz and when the voltage value was ±7.5 V and the frequency was 0.01 Hz to 0.05 Hz, a phenomenon in which the electrophoretic particles 54 polarized and adhered to one another was observed.

When the voltage value was ±5.0 V to ±6.0 V and the frequency was 0.02 Hz to 0.05 Hz, it was confirmed that a good flow of the electrophoretic particles 54 was achieved. Therefore, the frequency of the AC voltage applied between each of the second light transmissive electrodes 44 and an adjacent one of the third light transmissive electrodes 46 is preferably 0.02 Hz or more and 0.05 Hz or less.

### Example 3

In the present example, using Solvent 1 of Example 1, a light beam direction control element 200 in which the configuration of light transmitting regions 20, a light absorbing region 30, second light transmissive electrodes 44, and third light transmissive electrodes 46 was different from the configuration in Example 1 (Embodiment 1) was produced. First, a specific configuration of the light transmitting regions 20, the light absorbing region 30, the second light transmissive electrodes 44, and the third light transmissive electrodes 46 is described.

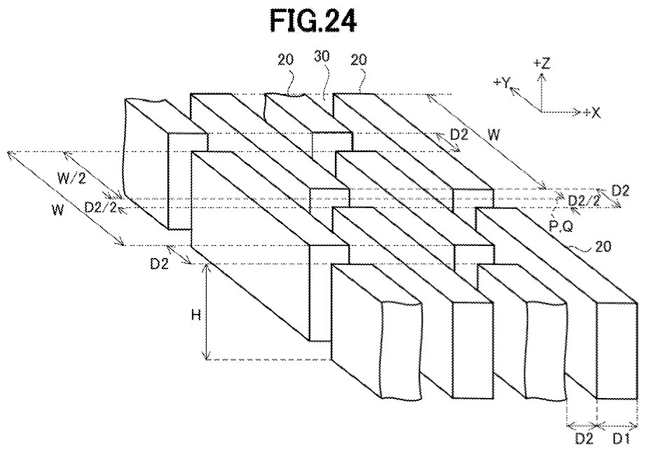

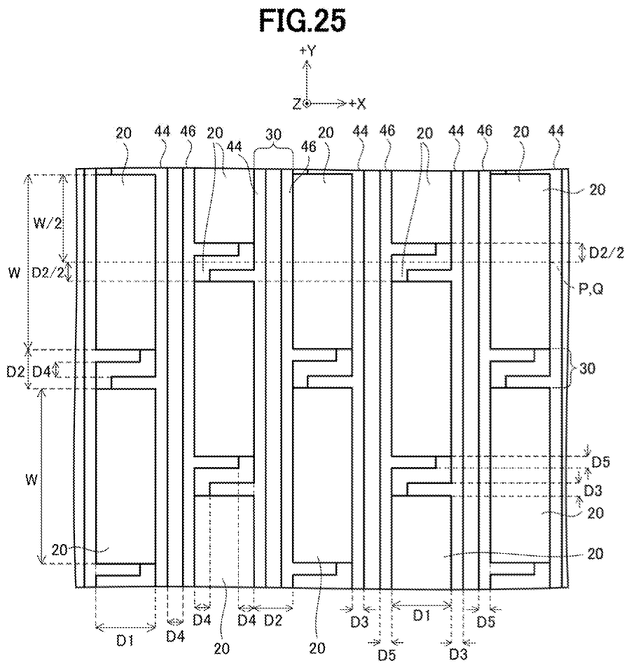

In the present example, as illustrated in FIGS. 24 and 25, rectangular parallelepiped-shaped light transmitting regions 20 are arranged in line in the Y-direction with gap (width of the light absorbing region 30) D2 interposed therebetween. Width (length in the X-direction) D1 of each light transmitting region 20 is 48 μm, and length (depth) W in the Y-direction of each light transmitting region 20 is 140 μm. Height H of the light transmitting regions 20 (height of the light absorbing region 30) is 100 μm.

In addition, rows of light transmitting regions 20 arranged in line in the Y-direction are arranged in line in the X-direction with the gap (width of the light absorbing region 30) D2 interposed therebetween. Between adjacent rows of light transmitting regions 20 arranged in line in the Y-direction, the positions in the Y-direction of the light transmitting regions 20 are shifted from each other by distance (W+D2)/2.

The light absorbing region 30 of the present embodiment is, as with the light absorbing regions 30 in Embodiments 1 and 2 and Examples 1 and 2, a region between adjacent light transmitting regions 20. Between rows of light transmitting regions 20 arranged in line in the Y-direction, a portion of the light absorbing region 30 extends in the Y-direction. Between light transmitting regions 20 arranged in line in the Y-direction, a portion of the light absorbing region 30 extends in the X-direction. Since, between adjacent rows of light transmitting regions 20 arranged in line in the Y-direction, the positions in the Y-direction of the light transmitting regions 20 are shifted from each other by a distance (W+D2)/2, a central line P extending in the X-direction of portions of the light absorbing region 30 extending in the X-direction and a bisector Q extending in the X-direction of light transmitting regions 20 of a row of light transmitting regions 20 adjacent to a row of the light transmitting regions 20 that defines portions of the light absorbing region 30 extending in the X-direction coincide with each other when viewed in plan.

Each of the second light transmissive electrodes 44 extends in the Y-direction along an edge on the −X side of one of the portions of the light absorbing region 30 extending in the Y-direction, as illustrated in FIG. 25. In addition, each of the second light transmissive electrodes 44 branches in the X-direction and each of branched portions of the second light transmissive electrode 44 extends along an edge on the −Y side of one of the portions of the light absorbing region 30 extending in the X-direction.

Each of the third light transmissive electrodes 46 extends in the Y-direction along an edge on the +X side of one of the portions of the light absorbing region 30 extending in the Y-direction. In addition, each of the third light transmissive electrodes 46 branches in the X-direction and each of branched portions of the third light transmissive electrodes 46 extends along an edge on the +Y side of one of the portions of the light absorbing region 30 extending in the X-direction.

In the present example, four types of light beam direction control elements 200 were produced by changing the gap D4 between each of the second light transmissive electrodes 44 and an adjacent one of the third light transmissive electrodes 46 (D4=8 μm, 15 μm, 40 μm, and 90 μm). The width D3 of each of the second light transmissive electrodes 44 and the width D5 of each of the third light transmissive electrodes 46 are 4 μm. The width D2 of the light absorbing region 30 is set to, depending on the gap D4 between each of the second light transmissive electrodes 44 and an adjacent one of the third light transmissive electrodes 46, 16 μm (D4=8 μm), 23 μm (D4=15 μm), 48 μm (D4=40 μm), and 98 μm (D4=90 μm).

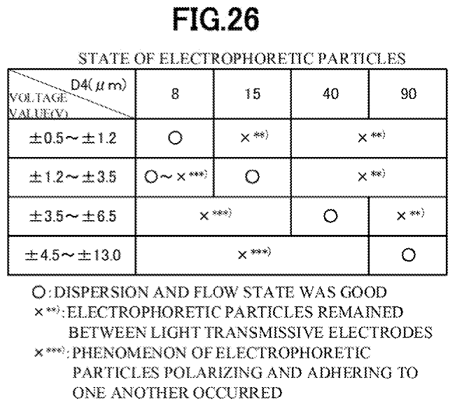

The states of the electrophoretic particles 54 of the produced light beam direction control elements 200 were visually observed while changing the voltage value of AC voltage (0.02 Hz to 0.05 Hz, pulse-shaped) applied between each of the second light transmissive electrodes 44 and an adjacent one of the third light transmissive electrodes 46. FIG. 26 illustrates an evaluation result of the light beam direction control elements 200 of the present example.

As illustrated in FIG. 26, when the gap D4 was 8 μm, it was confirmed that a good flow of the electrophoretic particles 54 was achieved by applying an AC voltage of ±0.5 V to ±1.2 V. In addition, when the gap D4 was 15 μm, it was confirmed that a good flow of the electrophoretic particles 54 was achieved by applying an AC voltage of ±1.2 V to ±3.5 V. When the gap D4 was 40 μm, it was confirmed that a good flow of the electrophoretic particles 54 was achieved by applying an AC voltage of ±3.5 V to ±6.5 V. Further, when the gap D4 was 90 μm, it was confirmed that a good flow of the electrophoretic particles 54 was achieved by applying an AC voltage of ±4.5 V to ±13.0 V.

When it is assumed that an AC voltage value at which it was confirmed that a good flow of the electrophoretic particles 54 was achieved was an optimum voltage value, a phenomenon in which the electrophoretic particles 54 polarized and adhered to one another was observed when an AC voltage higher than the optimum voltage value was applied. In addition, when an AC voltage lower than the optimum voltage value was applied, the electrophoretic particles 54 remained between each of the second light transmissive electrodes 44 and an adjacent one of the third light transmissive electrodes 46.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A light beam direction control element, comprising:
a light beam direction controller; and
a controller to control an angular distribution of light emitted from the light beam direction controller, wherein
the light beam direction controller includes:
a first light transmissive substrate having a first light transmissive electrode on a principal surface;
a second light transmissive substrate opposed to the first light transmissive substrate and having second light transmissive electrodes and third light transmissive electrodes on a principal surface opposed to the principal surface of the first light transmissive substrate;
a plurality of light transmitting regions arranged in line in a predetermined direction and sandwiched between the first light transmissive substrate and the second light transmissive substrate;
a plurality of light absorbing regions located between the light transmitting regions;
a light transmissive dispersion medium sealingly contained in the light absorbing regions; and
electrophoretic particles absorbing light, dispersed in the light transmissive dispersion medium, and having a dispersion state changing by applied voltage,
the second light transmissive electrodes and the third light transmissive electrodes are arranged at positions overlapping the light absorbing regions with a gap interposed between each of the second light transmissive electrodes and an adjacent one of the third light transmissive electrodes, and
the controller, by controlling voltage applied to the electrophoretic particles from the first light transmissive electrode, the second light transmissive electrodes, and the third light transmissive electrodes, causes the electrophoretic particles to localize to the second light transmissive substrate side and also causes the electrophoretic particles to flow between a space over each of the second light transmissive electrodes and a space over an adjacent one of the third light transmissive electrodes.

2. The light beam direction control element according to claim 1, wherein the controller applies DC voltage between the first light transmissive electrode and the second light transmissive electrodes and third light transmissive electrodes and also applies AC voltage between each of the second light transmissive electrodes and an adjacent one of the third light transmissive electrodes.

3. The light beam direction control element according to claim 2, wherein frequency of the AC voltage is 0.02 Hz or more and 0.05 Hz or less.

4. The light beam direction control element according to claim 1, wherein
when viewed in plan,
the light transmitting regions are arranged in a matrix,
each of the second light transmissive electrodes and each of the third light transmissive electrodes surround one of the light transmitting regions, and
the second light transmissive electrodes and the third light transmissive electrodes are alternately arranged.

5. A display device, comprising:
the light beam direction control element according to claim 1; and
a display panel, wherein
the light beam direction controller of the light beam direction control element is arranged on a display surface of the display panel.

6. A display device, comprising:
the light beam direction control element according to claim 1;
a transmission-type liquid crystal display panel; and
a backlight arranged on an opposite side to a display surface of the transmission-type liquid crystal display panel and to supply the transmission-type liquid crystal display panel with light, wherein
the light beam direction controller of the light beam direction control element is arranged between the transmission-type liquid crystal display panel and the backlight.

7. A method for driving a light beam direction control element, the method comprising:
causing electrophoretic particles dispersed in a dispersion medium, the dispersion medium being sealingly contained in light absorbing regions located between a first light transmissive substrate and a second light transmissive substrate, to localize to the second light transmissive substrate side by controlling voltage applied between a first light transmissive electrode on the first light transmissive substrate and second light transmissive electrodes and third light transmissive electrodes on the second light transmissive substrate; and
causing the electrophoretic particles having been caused to localize to the second light transmissive substrate side to flow between a space over each of the second light transmissive electrodes and a space over an adjacent one of the third light transmissive electrodes by controlling voltage applied between the second light transmissive electrode and the third light transmissive electrode.
